(19) United States
(12) Patent Application Publication
(10) Pub. No.: US 2026/0323052 A1
(43) Pub. Date: Oct. 15, 2026

(54) MEDIA FILE GENERATION METHOD AND APPARATUS, ELECTRONIC DEVICE, AND STORAGE MEDIUM

(71) Applicants: DOUYIN VISION CO., LTD., Beijing (CN); Lemon Inc., Grand Cayman (KY)

(72) Inventors: Lixiang Pan, Beijing (CN); Jicheng Wang, Beijing (CN); Yubo Li, Beijing (CN); Zhiwen Song, Singapore (SG)

(21) Appl. No.: 19/119,096

(22) PCT Filed: Mar. 12, 2024
(86) PCT No.: PCT/CN2024/081251

§ 371 Date: Apr. 7, 2025

(30) Foreign Application Priority Data
Mar. 14, 2023 (CN) 202310266459.5

(51) Int. Cl. H04N 19/40; H04N 7/01; H04N 19/70

(52) U.S. Cl. CPC H04N 19/40; H04N 7/01; H04N 19/70

(57) ABSTRACT

Embodiments of the present disclosure provide a media file generating method and apparatus, an electronic device, and a storage medium. The method includes: determining a first format media file and a second format media file; determining preset file index information from the first format media file; and regenerating, based on the preset file index information, the first format media file by using the second target media data in the second format media file. By performing the solution, the problem that various encapsulation formats contain redundant data can be solved, and a storage space can be saved.

This application claims priority to Chinese Patent Application No. 202310266459.5, entitled “MEDIA FILE GENERATION METHOD AND APPARATUS, ELECTRONIC DEVICE, AND STORAGE MEDIUM”, filed with the China National Intellectual Property Administration on Mar. 14, 2023, the disclosure of which is incorporated herein by reference in its entirety.

### FIELD

Embodiments of the present disclosure relate to a data processing technology, and in particular, to a media file generating method and apparatus, an electronic device, and a storage medium.

### BACKGROUND

Due to the diversity of end sides and a need of playing media files in different encapsulation formats in different scenarios, media files in various encapsulation formats may be generated simultaneously during transcoding of a server side.

Encoding parameters of media files in different encapsulation formats are the same. The media files are only encapsulated in different formats, so internally contained transcoding stream data is the same. If media files in different encapsulation formats are prepared for storage and use for media data with the same content, a large storage space may be occupied, causing a waste of storage space and then leading to a problem of data redundancy.

### SUMMARY

The present disclosure provides a media file generating method and apparatus, an electronic device, and a storage medium, which can solve the problem that various encapsulation formats contain redundant data, and save storage space.

In a first aspect, an embodiment of the present disclosure provides a media file generating method, including:

determining a first format media file and a second format media file, wherein the first format media file is obtained by converting the second format media file into a preset encapsulation format;

determining preset file index information from the first format media file, wherein the preset file index information records a mapping correspondence relationship from first target media data to second target media data; the first target media data comprises target media data that has been deleted from the first format media file; the second target media data comprises target media data, which has the same data content as the first target media data, in the second format media file; and

regenerating, based on the preset file index information, the first format media file using the second target media data in the second format media file.

In a second aspect, an embodiment of the present disclosure provides a media file determining

apparatus, including:

a media file determining module, configured to determine a first format media file and a second format media file, wherein the first format media file is obtained by converting the second format media file into a preset encapsulation format;

a preset file index information determining module, configured to determine preset file index information from the first format media file, wherein the preset file index information records a mapping correspondence relationship from first target media data to second target media data; the first target media data includes target media data that has been deleted from the first format media file; the second target media data includes target media data, which has the same data content as the first target media data, in the second format media file; and

a media data generating module, configured to regenerate, based on the preset file index information, the first format media file using the second target media data in the second format media file.

In a third aspect, an embodiment of the present disclosure provides an electronic device, including:

one or more processors; and

a storage, configured to store one or more programs,

wherein the one or more programs, when executed by the one or more processors, cause the one or more processors to implement the media file generating method described in any embodiment of the present disclosure.

In a fourth aspect, an embodiment of the present disclosure further provides a storage medium including computer-executable instructions. The computer-executable instructions, when executed by a computer processor, are used for performing the media file generating method described in any embodiment of the present disclosure.

In the embodiments of the present disclosure, a first format media file and a second format media file are determined, wherein the first format media file is obtained by converting the second format media file into a preset encapsulation format; preset file index information is determined from the first format media file, wherein the preset file index information records a mapping correspondence relationship from first target media data to second target media data; the first target media data includes target media data that has been deleted from the first format media file; the second target media data includes target media data, which has the same data content as the first target media data, in the second format media file; and the first format media file by is regenerated based on the preset file index information using the second target media data in the second format media file. Media files in different encapsulation formats are prepared for storage and use for media data with the same content, so that a large storage space may be occupied, causing a waste of storage space and then leading to a problem of data redundancy. In this solution, the preset file index information is determined from the first format media file, and the first format media file is regenerated based on the preset file index information using the second target media data in the second format media file, so that the problems of the waste of storage space and the data redundancy are solved; the storage space can be saved; and the effective utilization rate of the storage space can be increased.

### BRIEF DESCRIPTION OF THE DRAWINGS

The above and other features, advantages, and aspects of the various embodiments of the present disclosure will become more apparent by combining the accompanying drawings and referring to the following specific implementations. Throughout the accompanying drawings, identical or similar reference numerals represent identical or similar elements. It should be understood that the accompanying drawings are illustrative, and components and elements may not necessarily be drawn to scale.

FIG. 1a is a flowchart of a media file generating method according to an embodiment of the present disclosure;

FIG. 1b is a schematic structural diagram of an MP4 file according to an embodiment of the present disclosure;

FIG. 2a is a flowchart of another media file generating method according to an embodiment of the present disclosure;

FIG. 2b is a schematic diagram of a distribution of media data of an MP4 file and media data of a dash file according to an embodiment of the present disclosure;

FIG. 3 is a schematic structural diagram of a media file determining apparatus according to an embodiment of the present disclosure; and

FIG. 4 is a schematic structural diagram of an electronic device according to an embodiment of the present disclosure.

### DETAILED DESCRIPTION OF EMBODIMENTS

The embodiments of the present disclosure will be described in detail below with reference to the accompanying drawings. Although the accompanying drawings show some embodiments of the present disclosure, it should be understood that the present disclosure can be implemented in various forms, and should not be explained as being limited to the embodiments stated herein. Rather, these embodiments are provided for understanding the present disclosure more thoroughly and completely. It should be understood that the accompanying drawings and embodiments of the present disclosure are only used for illustration, but are not intended to limit the protection scope of the present disclosure.

It should be understood that respective steps recorded in method implementations of the present disclosure can be executed in different orders and/or in parallel. In addition, the method implementations may include additional steps and/or omit the execution of the steps shown. The scope of the present disclosure is not limited in this aspect.

The term “include” and its variants as used herein mean widespread inclusion, namely, “including but not limited to”. The term “based on” is “based at least in part on”. The term “one embodiment” means “at least one embodiment”. The term “another embodiment” means “at least another embodiment”. The term “some embodiments” means “at least some embodiments”. Relevant definitions of other terms will be given in the description below.

It should be noted that the concepts such as “first” and “second” mentioned in the present disclosure are only used to distinguish different apparatuses, modules, or units, and are not intended to limit the order or interdependence of the functions performed by these apparatuses, modules, or units.

It should be noted that the modifications of “one” and “plurality” mentioned in the present disclosure are indicative rather than restrictive, and those skilled in the art should understand that unless otherwise explicitly stated in the context, they should be understood as “one or more”.

Names of messages or information interacted between a plurality of apparatuses in the implementations of the present disclosure are only for illustrative purposes and are not intended to limit the scopes of these messages or information.

It may be understood that before use of the technical solutions disclosed in various embodiments of the present disclosure, users should be informed of the type, scope of use, usage scenarios, etc of personal information involved in the present disclosure in accordance with relevant laws and regulations in an appropriate manner, so as to obtain authorization from the users.

For example, in response to that an active request of a user has been received, prompt information is sent to the user to clearly remind the user that personal information of the user needs to be involved in an operation requested to be executed. Thus, the user can independently select whether to provide the personal information to software or hardware such as an electronic device, an application program, a server, or a storage medium that performs the operation of the technical solutions of the present disclosure according to the prompt information.

As an optional but non-restrictive implementation, in response to that an active request of a user has been received, prompt information is sent to the user through, for example, a pop-up window where the prompt information can be presented in text. In addition, the pop-up window can also carry a selection control for the user to select whether to “agree” or “refuse” to provide the personal information to the electronic device.

It may be understood that the above notification and the above user authorization obtaining process are only illustrative and do not constitute a limitation on the implementations of the present disclosure. Other methods that meet the relevant laws and regulations can also be applied to the implementations of the present disclosure.

It may be understood that data involved in the technical solutions (including but not limited to the data itself, and obtaining or use of the data) should comply with the requirements of corresponding laws and regulations and relevant provisions.

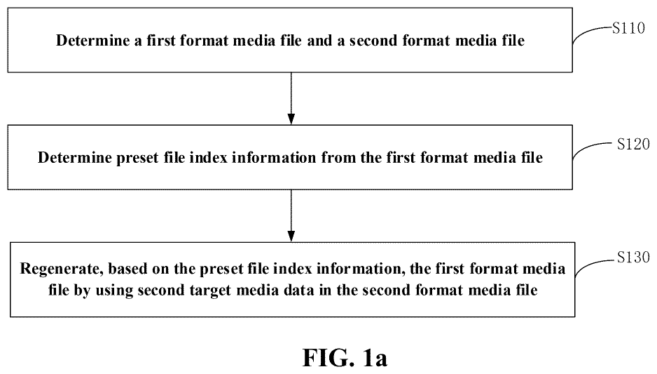

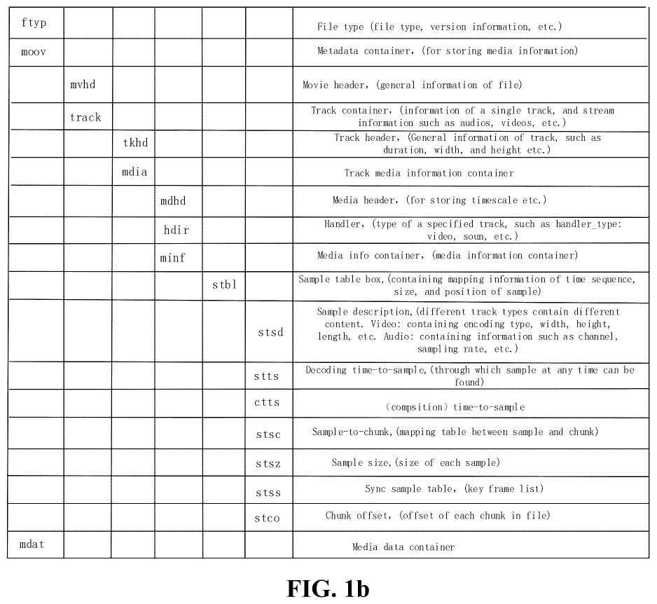

FIG. 1a is a flowchart of a media file generating method according to an embodiment of the present disclosure; This embodiment of the present disclosure is applicable to a situation for quick regeneration of a media file. The method may be performed by a media file determining apparatus. The apparatus may be implemented in the form of software and/or hardware. Optionally, the apparatus is implemented through an electronic device. The electronic device may be a mobile terminal, a Personal Computer (PC) end, a server, or the like. As shown in FIG. 1a, the method includes:

S110. A first format media file and a second format media file are generated,

wherein the first format media file is obtained by converting the second format media file into a preset encapsulation format,

wherein the first format media file is a file from which media data is deleted. The second format media file is a file that retains media data. An encoding parameter of the first format media file is the same as an encoding parameter of the second format media file. Transcoding stream data of the first format media file is the same as transcoding stream data of the second format media file, but the first format media file and the second format media file have different encapsulation formats. The first format media file being an MP4 file is taken as an example. The second format media file may be a dash file or an Http Live Streaming (HLS) file other than an MP4 file. This solution takes the MP4 file serving as the first format media and the dash file serving as the second format media file as an example for explanation.

S120. Preset file index information is determined from the first format media file,

wherein the preset file index information records a mapping correspondence relationship from first target media data to second target media data; the first target media data comprises target media data that has been deleted from the first format media file; and the second target media data comprises target media data, which has the same data content as the first target media data, in the second format media file.

The first target media data and the second target media data record the same data content. The first target media data belongs to the first format media file, and the second target media data is stored in the second format media file. The first format media file further contains preset file index information. Based on the preset file index information, a mapping correspondence relationship from the first target media data that has been deleted from the first format media file to the second target media data that has the same data content in the second format media file can be determined. The mapping correspondence relationship can be used as a guide for a user to obtain the second target media data, corresponding to the first target media data, in the second format media file when the user searches for the first target media data, and regenerating the first format media file according to the second target media data. It may be understood that media data may be audio data or video data.

S130. The first format media file is regenerated based on the preset file index information using the second target media data in the second format media file.

Among them, when the first target media data is accessed, based on the preset file index information and the second format media file, this solution can determine the first target media data that has been deleted from the first format media file, which can save a memory space and reduce redundant data.

In an optional but non-limitative implementation, a mode for generating the first format media file includes but is not limited to step A1 to step A3:

Step A1: Encapsulation format conversion is performed on the second format media file to obtain a reference media file, and deleting the first target media data from the reference media file.

For example, the first format media file being the MP4 file and the second format media file being the dash file are taken as an example. This solution can perform the encapsulation format conversion on the dash file to obtain the reference media file, and then the first target media data is deleted from the reference media file. As shown in FIG. 1b, the reference media file may be a complete MP4 file that includes header data and media data.

Step A2: Metadata information in the reference media file is analyzed to obtain the preset file index information, wherein the metadata information includes preset description information of all media data in the reference media file.

As shown in FIG. 1b, the metadata information may be information in stco box of the reference media file, and the metadata information may include an offset value, before deletion, of each media data block of the first target media data that has been deleted from the MP4 file mdat data. By analyzing the metadata information in the reference media file, this solution can obtain the offset values, before deletion, of the media data blocks that have been deleted from the mdat data of the MP4 file, and then obtain the preset file index information according to the offset values.

Step A3: The preset file index information is added to the reference media file from which the first target media data has been deleted, to obtain the first format media file.

This solution adds the preset file index information to the reference media file from which the first target media data has been deleted, to obtain the first format media file, which can provide a reliable data basis for regeneration of media data that has been deleted from the first format media file.

Thus, the encapsulation format conversion is performed on the second format media file to obtain the reference media file, and the first target media data is deleted from the reference media file. The preset file index information is obtained by analyzing the metadata information in the reference media file. The metadata includes the preset description information of all the media data in the reference media file. The preset file index information is added to the reference media file from which the first target media data has been deleted, to obtain the first format media file. Mutual conversion between media files in different formats can be achieved, which can improve the reliable data basis for subsequent determination of media data.

In the embodiments of the present disclosure, a first format media file and a second format media file are determined, wherein the first format media file is obtained by converting the second format media file into a preset encapsulation format; preset file index information is determined from the first format media file, wherein the preset file index information records a mapping correspondence relationship from first target media data to second target media data; the first target media data includes target media data that has been deleted from the first format media file; the second target media data includes target media data, which has the same data content as the first target media data, in the second format media file; and the first format media file by is regenerated based on the preset file index information using the second target media data in the second format media file. Media files in different encapsulation formats are prepared for storage and use for media data with the same content, so that a large storage space may be occupied, causing a waste of storage space and then leading to a problem of data redundancy. In this solution, the preset file index information is determined from the first format media file, and the first format media file is regenerated based on the preset file index information using the second target media data in the second format media file, so that the problems of the waste of storage space and the data redundancy are solved; the storage space can be saved; and the effective utilization rate of the storage space can be increased.

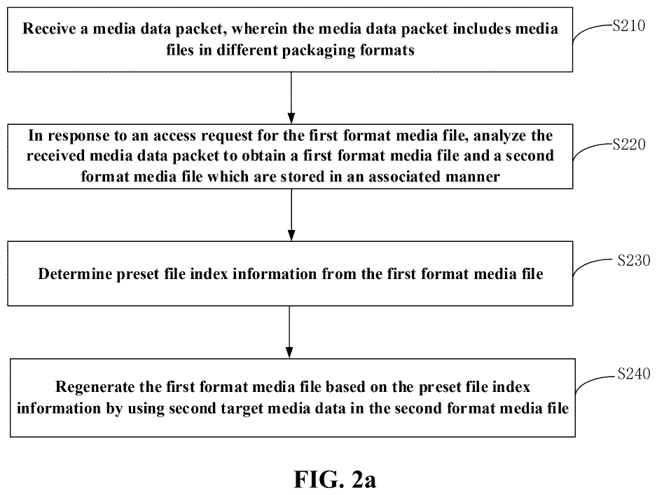

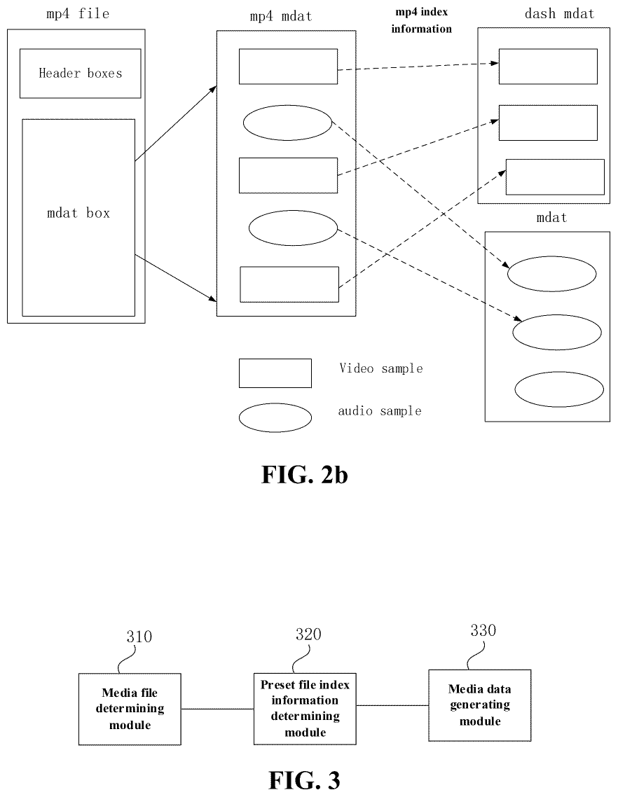

FIG. 2a is a flowchart of another media file generating method according to an embodiment of the present disclosure. This embodiment of the present disclosure will further optimize the foregoing embodiment based on the above embodiment. This embodiment of the present disclosure can be combined with the optional solutions in one or more embodiments. As shown in FIG. 2a, the media file generating method according to this embodiment of the present disclosure may include the following steps:

S210. A media data packet is received, wherein the media data packet includes media files in different encapsulation formats.

The media data packet may include media files that are in different encapsulation formats but have the same encoding parameters and transcoding stream data. For example, the media data packet may include a first format media file and a second format media file.

S220. In response to an access request for the first format media file, the received media data packet is analyzed to obtain the first format media file and the second format media file which are stored in an association,

wherein the second target media data that has the same data content as the first target media data is not deleted from the second format media file; and an audio and video encoding parameter used in the first format media file and an audio and video encoding parameter used in the second format media file are the same.

Specifically, this solution can respectively determine the first format media file and the second format media file from the received media data packet according to the access request for the first format media file. The first target media data has been deleted from the first format media file, and the second format media file includes the second target media data that has the same data content as the first target media data. The audio and video encoding parameter and transcoding stream data used in the first format media file are the same as those used in the second format media file, which can achieve the regeneration of the first target media data through the second format media file.

S230. Preset file index information is determined from the first format media file.

In an optional but non-limitative implementation, the preset file index information includes a mapping correspondence relationship from first offset information to second offset information; the first offset information describes a first offset position of the first target media data before deletion relative to the first format media file; and the second offset information describes a second offset position of the second target media data relative to the second format media file.

For example, assuming that the first offset position, before deletion relative to the first format media file, of the first target media data that has been deleted from the first format media file is represented by offset n, and the second offset position, relative to the second format media data, of the second target media data that has the same data content as the first target media data is represented by reference n. The mapping correspondence relationship between the first offset information and the second offset information in the preset file index information may be represented below: (“offset n”, “reference n”). By determining the mapping correspondence relationship between the first offset information and the second offset information in the preset file index information, regeneration of media data in a media file in another encapsulation format according to a media file in one encapsulation format can be achieved.

In an optional but non-limitative implementation, the preset file index information further includes media type information; the media type information describes a media type of the same target media data corresponding to a mapping from the first offset information to the second offset information; and the media type information is represented by a numerical value.

For example, assuming that the first offset information is represented by offset n, the second offset information is represented by reference n, and the media type information is represented by type x, the preset file index information may be represented as follows: (“offset n”, “type x”, “reference n”). Where type x describes the media type of the same target media data corresponding to the mapping between the first offset information and the second offset information; and the media type information is represented by a numerical value. For example, when x is 1, type 1 indicates that the media data type is video data. When x is 2, type 2 indicates that the media data type is audio data. By determining the preset file index information that contains the media type information, regeneration of media data in a media file in another encapsulation format according to a media file in one encapsulation format can be achieved.

In an optional but non-limitative implementation, a mode for generating the preset file index information includes but is not limited to step B1 to step B2:

Step B1: The first offset position of the first target media data before deletion relative to the first format media file is determined,

wherein the first target media data may be any media data that has been deleted from the first format media file. This solution can determine, according to header data in the first format media file, the first offset position, before deletion relative to the first format media file, of the first target media data that has been deleted from the first format media file, thereby providing a reliable data basis for construction of the preset file index information.

Step B2: The second offset position of the second target media data relative to the second format media file is determined from the second format media file.

This solution can determine, according to the first target media data, the second target media data that has the same data content as the first target media data from the second format media file based on the first target media data, and then determine the second offset position of the second target media data relative to the second format media file according to offset positions of media data blocks stored in the second format media file.

Step B3: The preset file index information is constructed by performing mapping correspondence on the first offset position and the second offset position which point to the same target media data.

Specifically, this solution can perform offset position mapping correspondence on the first offset position and the second offset position which point to the same data and are determined in the previous step, to obtain the preset file index information. Regeneration of media data in a media file in another encapsulation format according to a media file in one encapsulation format can be achieved.

In an optional but non-limitative implementation, the first offset position of the first target media data before deletion relative to the first format media file, which includes but is not limited to step C1 to step C2:

Step C1: Each of the first target media data is interleaved and sorted based on media types of the first target media data, according to a size of each of the first target media data that has been deleted from the first format media file.

The first format media file being an MP4 file is taken as an example. This solution can interleave and sort each of the first target media data based on the media types of the first target media data, according to the sizes of each of the first target media data that has been deleted from the MP4 file. As shown in FIG. 2b, audio data segments and video data segments in the MP4 file are crosswise arranged in sequence.

Step C2: The first offset position, before deletion relative to the first format media file, of each of the first target media data that is interleaved and sorted and the media types of the first target media data are recorded, wherein the media types of at least two adjacent pieces of the first target media data that is interleaved and sorted are different.

Specifically, this solution can record the first offset position, before deletion relative to the first format media file, of each of the first target media data that is interleaved and sorted and the media types of the first target media data. For example, this solution can record the offset positions, before deletion relative to the MP4 file, of the segments of audio data that are interleaved and sorted. This solution can further record the offset positions, before deletion relative to the MP4 file, of the segments of video data that are interleaved and sorted. The media types of two adjacent pieces of first target media data are different.

Therefore, each of the first target media data is interleaved and sorted based on the media types of the first target media data, according to the size of each of the first target media data that has been deleted from the first format media file. The first offset position, before deletion relative to the first format media file, of each of the first target media data that is interleaved and sorted and the media types of the first target media data are recorded, wherein the media types of at least two adjacent pieces of first target media data that are interleaved and sorted are different. A reliable data basis can be provided for the generation of the preset file index information.

In an optional but non-limitative implementation, the second offset position of the second target media data relative to the second format media file is determined from the second format media file may include but not limited to the following process:

when a current piece of the first target media data that has been deleted from the first format media file is headmost piece of target media data, searching the second target media data of the second format media file for headmost piece of target media data according to the media type of the current piece of the first target media data, and determining the headmost piece of target media data to be second target media data that is the same as the current piece of the first target media data, wherein the searched headmost piece of target media data has the same media type as the current piece of the first target media data; and determining the second offset position of the second target media data relative to the second format media file.

For example, the first format media file being the MP4 file, the second format media file being a dash file, and the media type being video data are taken as an example. When the first target media data that has been deleted from the MP4 file is of a video type and is the headmost piece of target media data of the MP4 file, this solution can search the dash file for the headmost piece of target media data of the video type, determine the second target media data that is the same as the current piece of the first target media data, and determine the second offset position of the second target media data relative to the dash file. The second offset position of the second target media data relative to the second format media file can be determined, so that a reliable data basis can be provided for the generation of the preset file index information.

In an optional but non-limitative implementation, the second offset position of the second target media data relative to the second format media file is determined from the second format media file, which includes but is not limited to step D1 to step D2:

Step D1: When a current piece of the first target media data that has been deleted from the first format media file is not the headmost piece of target media data, a previous offset position and a current offset position are determined, and a size of a piece previous of the first target media data is determined according to the previous offset position and the current offset position, wherein the current offset position is a first offset position, before deletion relative to the first format media file, of the current piece of the first target media data that has been deleted from the first format media file; the previous offset position is a first offset position, before deletion relative to the first format media file, of the previous piece of the target media data that has been deleted from the first format media file and is in front of the current piece of the first target media data.

For example, when the current piece of the first target media data that has been deleted from the first format media file is not the headmost piece of target media data, this solution can determine both the first offset position, before deletion relative to the first format media file, of the current piece of the first target media data that has been deleted from the first format media file and the first offset position, before deletion relative to the first format media file, of the previous piece of the target media data that has been deleted from the first format media file and is in front of the current piece of the first target media data, and determine the size of the previous piece of the first target media according to the previous offset information and the current offset position.

For example, the first format media file being the MP4 file is taken as an example. When the current piece of the first target media data that has been deleted from the MP4 file is not the headmost piece of target media data, this solution can determine, from the MP4 file, the previous offset position offset m-1 and the current offset position offset m which are associated with the current piece of the first target media data, and then determine the size of the previous piece of the first target media according to a difference between offset m and offset m-1. The previous offset position offset m-1 is the first offset position, relative to the MP4 file before deletion, of the previous piece of the first target media of the current piece of the first target media data that has been deleted from the MP4 file. A reliable data basis can be provided for determining the offset position, relative to the second format media file, of the second target media data that has the same data content as the first target media data pointed to by the first offset position.

Step D2: According to the size of the previous piece of the first target media, the media type of the current piece of the first target media data, and a reference offset position, the second format media file is searched for the second target media data that is the same as the current piece of the first target media data; and the second offset position, relative to the second format media file, of the second target media data that is the same as the current piece of the first target media data is determined,

wherein the reference offset position is the second offset position of second target media data, which is the same as the previous piece of the first target media, in the second format media file relative to the second format media file.

The media type of the current piece of the first target media data being the video type, offset n representing the first offset position, and reference n representing the second offset position are taken as an example. Since the first offset position, relative to the MP4 file before deletion of video data, of each video data segment that has been deleted from the MP4 file can be determined, and the second offset position of a headmost piece of video data segment in the second format media file may be determined too, this solution can search the second format media file for and determine, according to the size of the previous piece of the first target media, the difference between offset m and offset m-1, the video type, and the reference offset position reference m-1, the second offset position reference m, relative to the second format media file, of the second target media data that is the same as the current piece of the first target media data. The reference offset position may be the second offset position, relative to the second format media file, of the second target media data, having the same data content as the previous piece of the first target media, in the second format media file. The second offset position of the second target media data relative to the second format media file can be determined, so that a reliable data basis can be provided for the generation of the preset file index information.

S240. The first format media file is regenerated based on the preset file index information using the second target media data in the second format media file.

In an optional but non-limitative implementation, the first format media file is regenerated based on the preset file index information using the second target media data in the second format media file, which includes but is not limited to step E1 to step E3:

Step E1: During accessing to the first format media file, pre-reserved file header data is read from the first format media file, wherein the pre-reserved file header data records the first offset information.

The first format media file being the MP4 file is taken as an example. This solution can access a stco box file of the pre-reserved file header data in the MP4 file. The stco box file records the first offset information, relative to the MP4 file, of the first target media data that has been deleted.

Step E2: First offset information required by the first target media data that has been deleted is read from the pre-reserved file header data.

This solution can read, from the stco box file of the pre-reserved file header data, the first offset information required by the first target media data that has been deleted.

Step E3: The first format media file is regenerated using the second target media data in the second format media file according to the first offset information required by the first target media data that has been deleted and the preset file index information.

This solution can determine the first target media data that has been deleted from the first format media file according to the first offset information required by the first target media data that has been deleted and the preset file index information, thereby achieving regeneration of media data. Regeneration of media data in a media file in another encapsulation format based on the preset file index information and a media file in one encapsulation format can be achieved, so that a storage space can be saved.

In an optional but non-limitative implementation, the first format media file is regenerated using the second target media data in the second format media file according to the first offset information required by the first target media data that has been deleted and the preset file index information, which includes but is not limited to step F1 to step F2:

Step F1: The first offset information required by the first target media data that has been deleted is matched with the preset file index information to obtain an offset information matching result, wherein the offset information matching result includes second offset information that is in mapping association with the first offset information required by the first target media data that has been deleted.

It is assumed that the media type of the first target media data is the video type; the first offset information required by the first target media data that has been deleted is represented by offset 3; and the second offset information of the second target media data that has the same data content as the first target media data is represented as reference 3. This solution can match offset 3 with mapping information (“offset 3”, “type 1”, “reference 3”) in the preset file index information, to obtain the second offset information reference 3 associated with the mapping of the first offset information required by the first target media data that has been deleted.

Step F2: Media data at corresponding offset positions is read from the second target media data of the second format media file according to the offset information matching result, and the read media data is added into the first format media file to reassemble and regenerate the first format media file.

Specifically, this solution can determine, according to the first offset information required by the deleted first target media data, the second offset information reference 3 mapped and associated with the first offset information; then read, according to the second offset information reference 3, the video data at the corresponding offset positions from the second target media data storing media data in the second format media file; and add the read video data into the first format media file to reassemble and generate the first format media file. Regeneration of media data in a media file in another encapsulation format based on the preset file index information and a media file in one encapsulation format can be achieved, so that a storage space can be saved.

According to this embodiment of the present disclosure, a media data packet is received, wherein the media data packet includes media files in different encapsulation formats; and in response to an access request for the first format media file, the received media data packet is analyzed to obtain the first format media file and the second format media file which are stored in an association, wherein the second target media data that has the same data content as the first target media data is not deleted from the second format media file, and an audio and video encoding parameter used in the first format media file and an audio and video encoding parameter used in the second format media file are the same; preset file index information is determined from the first format media file, wherein the preset file index information records a mapping correspondence relationship from the first target media data that has been deleted from the first format media file to the second target media data, having the same data content, in the second format media file; and the first format media file is regenerated using the second target media data in the second format media file based on the preset file index information. Media files in different encapsulation formats are prepared for storage and use for media data with the same content, so that a large storage space may be occupied, causing a waste of storage space and then leading to a problem of data redundancy. In this solution, the preset file index information is determined from the first format media file, and the first format media file is regenerated based on the preset file index information using the second target media data in the second format media file, so that the problems of the waste of storage space and the data redundancy are solved; the storage space can be saved; and data redundancy can be reduced.

FIG. 3 is a schematic structural diagram of a media file determining apparatus according to an embodiment of the present disclosure. As shown in FIG. 3, the apparatus includes:

a media file determining module 310, configured to determine a first format media file and a second format media file, wherein the first format media file is obtained by converting the second format media file into a preset encapsulation format;

a preset file index information determining module 320, configured to determine preset file index information from the first format media file, wherein the preset file index information records a mapping correspondence relationship from first target media data to second target media data; the first target media data includes target media data that has been deleted from the first format media file; the second target media data includes target media data, which has the same data content as the first target media data, in the second format media file; and

a media data generating module 330, configured to regenerate, based on the preset file index information, the first format media file using the second target media data in the second format media file.

In an optional solution of this embodiment of the present disclosure, optionally, the media file determining module 310 includes a reference media file determination unit, configured to: perform encapsulation format conversion on the second format media file to obtain a reference media file, and delete the first target media data from the reference media file; a file index information determination unit, configured to analyze metadata information in the reference media file to obtain the preset file index information, wherein the metadata information includes preset description information of all media data in the reference media file; and a first format media file determination unit, configured to add the preset file index information to the reference media file from which the first target media data has been deleted, to obtain the first format media file.

In an optional solution of this embodiment of the present disclosure, optionally, the media file determining module 310 includes a media data packet receiving unit, configured to receive a media data packet, wherein the media data packet includes media files in different encapsulation formats; and a media file determination unit, configured to: in response to an access request for the first format media file, analyze the received media data packet to obtain the first format media file and the second format media file which are stored in an association, wherein the second target media data that has the same data content as the first target media data is not deleted from the second format media file; and an audio and video encoding parameter used in the first format media file and an audio and video encoding parameter used in the second format media file are the same.

In an optional solution of this embodiment of the present disclosure, optionally, the preset file index information includes a mapping correspondence relationship from first offset information to second offset information; the first offset information describes a first offset position of the first target media data before deletion relative to the first format media file; and the second offset information describes a second offset position of the second target media data relative to the second format media file.

In an optional solution of this embodiment of the present disclosure, optionally, the preset file index information further includes media type information; the media type information describes a media type of the same target media data corresponding to a mapping from the first offset information to the second offset information; and the media type information is represented by a numerical value.

In an optional solution of this embodiment of the present disclosure, optionally, the preset file index information determining module 320 includes a first offset position determination unit, configured to determine the first offset position of the first target media data before deletion relative to the first format media file; a second offset position determination unit, configured to determine, from the second format media file, the second offset position of the second target media data relative to the second format media file; and a preset file index information determination unit, configured to construct the preset file index information by performing mapping correspondence on the first offset position and the second offset position which point to the same target media data.

In an optional solution of this embodiment of the present disclosure, optionally, the first offset position determination unit, specifically configured to: interleave and sort each of the first target media data based on media types of the first target media data, according to a size of each of the first target media data that has been deleted from the first format media file; and record the first offset position, before deletion relative to the first format media file, of each of the first target media data that is interleaved and sorted and the media types of the first target media data, wherein the media types of at least two adjacent pieces of first target media data that are interleaved and sorted are different.

In an optional solution of this embodiment of the present disclosure, optionally, the second offset position determination unit is specifically configured to: when a current piece of the first target media data that has been deleted from the first format media file is headmost piece of target media data, search the second target media data of the second format media file for headmost piece of target media data according to the media type of the current piece of the first target media data, and determine the headmost piece of target media data to be second target media data that is the same as the current piece of the first target media data, wherein the searched headmost piece of target media data has the same media type as the current piece of the first target media data; and determine the second offset position of the second target media data relative to the second format media file.

In an optional solution of this embodiment of the present disclosure, optionally, the second offset position determination unit is specifically configured to: when a current piece of the first target media data that has been deleted from the first format media file is not headmost piece of target media data, determine a previous offset position and a current offset position, and determine a size of a previous piece of the first target media data according to the previous offset position and the current offset position, wherein the current offset position is a first offset position, before deletion relative to the first format media file, of the current piece of the first target media data that has been deleted from the first format media file; the previous offset position is a first offset position, before deletion relative to the first format media file, of the previous piece of the target media data that has been deleted from the first format media file and is in front of the current piece of the first target media data; according to the size of the previous piece of the first target media, the media type of the current piece of the first target media data, and a reference offset position, search the second format media file for the second target media data that is the same as the current piece of the first target media data; and determine the second offset position, relative to the second format media file, of the second target media data that is the same as the current piece of the first target media data, wherein the reference offset position is the second offset position of second target media data, which is the same as the previous piece of the first target media, in the second format media file relative to the second format media file.

In an optional solution of this embodiment of the present disclosure, optionally, the media data generating module 330 includes a pre-reserved header data reading unit, configured to: during accessing to the first format media file, read pre-reserved file header data from the first format media file, wherein the pre-reserved file header data records the first offset information; a first offset information determination unit, configured to read, from the pre-reserved file header data, first offset information required by the first target media data that has been deleted; and a media data regenerating unit, configured to regenerate the first format media file using the second target media data in the second format media file according to the first offset information required by the first target media data that has been deleted and the preset file index information.

In an optional solution of this embodiment of the present disclosure, optionally, the media data regenerating unit is specifically configured to: match the first offset information required by the first target media data that has been deleted with the preset file index information to obtain an offset information matching result, wherein the offset information matching result includes second offset information that is in mapping association with the first offset information required by the first target media data that has been deleted; and read media data at corresponding offset positions from the second target media data of the second format media file according to the offset information matching result, and add the read media data into the first format media file to reassemble and regenerate the first format media file.

The media file determining apparatus provided in this embodiment of the present disclosure can implement the media file generating method provided in any embodiment of the present disclosure, and includes corresponding functional modules for implementing the method and corresponding beneficial effects.

It is worth noting that the various units and modules included in the above apparatus are only divided according to a functional logic, but are not limited to the above division, as long as the corresponding functions can be achieved. In addition, the specific names of the various functional units are only for the purpose of distinguishing and are not used to limit the protection scope of the embodiments of the present disclosure.

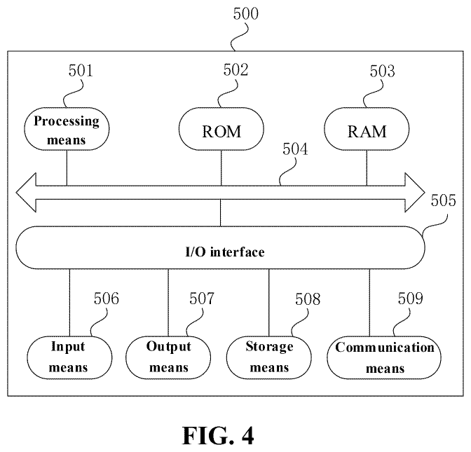

FIG. 4 is a schematic structural diagram of an electronic device according to the embodiments of the present disclosure. Reference is now made to FIG. 4 below, which illustrates a schematic structural diagram of an electronic device (namely, a terminal device or a server in FIG. 4) 500 suitable for implementing an embodiment of the present disclosure. The terminal device in the embodiments of the present application may include, but is not limited to, a mobile phone, a laptop, a digital broadcast receiver, a Personal Digital Assistant (PDA), a Portable Android Device (PAD), a Portable Media Player (PMP), a mobile terminal such as a vehicle-mounted terminal (for example, a vehicle-mounted navigation terminal), and a fixed terminal such as digital television (TV) and a desktop computer. The electronic device shown in FIG. 4 is only an example and should not impose any limitations on the functionality and scope of use of the embodiments of the present application.

As shown in FIG. 4, the electronic device 500 may include a processing means (such as a central processing unit and graphics processor) 501 that can perform various appropriate actions and processing according to programs stored in a Read-Only Memory (ROM) 502 or loaded from a storage 508 to a Random Access Memory (RAM) 503. The RAM 503 further stores various programs and data required for the operation of the electronic device 500. The processing means 501, the ROM 502, and the RAM 503 are connected to each other through a bus 504. An Input/Output (I/O) interface 505 is also connected to the bus 504.

Usually, following apparatuses can be connected to the I/O interface 505: an input means 506 including a touch screen, a touchpad, a keyboard, a mouse, a camera, a microphone, an accelerometer, a gyroscope, etc; an output means 507 including a Liquid Crystal Display (LCD), a speaker, a vibrator, etc; a storage 508 including a magnetic tape, a hard disk drive, etc; and a communication means 509. The communication means 509 can allow the electronic device 500 to wirelessly or wiredly communicate with other devices to exchange data. Although FIG. 4 shows the electronic device 500 with various apparatuses, it should be understood that the electronic device 500 is not required to implement or have all the apparatuses shown, and can alternatively implement or have more or fewer apparatuses.

Particularly, according to the embodiments of the present disclosure, the process described in the reference flowchart above can be implemented as a computer software program. For example, the embodiments of the present application include a computer program product, including a computer program carried on a non-transitory computer-readable medium, and the computer program includes program codes used for performing the methods shown in the flowcharts. In such an embodiment, the computer program may be downloaded and installed from a network through the communication means 509, or installed from the memory 508, or installed from the ROM 502. When the computer program is executed by the processing means 501, the above-mentioned functions defined in the methods of the embodiments of the present application are executed.

Names of messages or information interacted between a plurality of apparatuses in the implementations of the present disclosure are only for illustrative purposes and are not intended to limit the scopes of these messages or information.

The electronic device provided in this embodiment of the present application and the media file generating method provided in the above embodiment belong to the same concept. Technical details not fully described in this embodiment can be found in the above embodiment, and this embodiment has the same effects as the above embodiment.

An embodiment of the present disclosure provides a computer storage medium, having a computer program stored therein. The program, when executed by a processor, implements the media file generating method provided in the above embodiments.

It should be noted that the computer-readable medium mentioned in the present disclosure can be a computer-readable signal medium, a computer-readable storage medium, or any combination of the computer-readable signal medium and the computer-readable storage medium. The computer-readable storage medium can be, for example, but not limited to, electric, magnetic, optical, electromagnetic, infrared, or semiconductor systems, apparatuses, or devices, or any combination of the above. More specific examples of the computer-readable storage medium may include, but are not limited to: an electrical connection with one or more wires, a portable computer disk, a hard disk drive, a RAM, a ROM, an Erasable Programmable Read Only Memory (EPROM) or flash memory, an optical fiber, a Compact Disc Read-Only Memory (CD-ROM), an optical storage device, a magnetic storage device, or any suitable combination of the above. In the present disclosure, the computer-readable storage medium may be any tangible medium that contains or stores a program, and the program can be used by or in combination with an instruction execution system, apparatus, or device. In the present disclosure, the computer-readable signal media may include data signals propagated in a baseband or as part of a carrier wave, which carries computer-readable program codes. The propagated data signals can be in various forms, including but not limited to: electromagnetic signals, optical signals, or any suitable combination of the above. The computer-readable signal medium may also be any computer-readable medium other than a computer-readable storage medium. The computer-readable signal medium can send, propagate, or transmit programs for use by or in combination with an instruction execution system, apparatus, or device. The program codes contained in the computer-readable medium can be transmitted using any suitable medium, including but are not limited to: a wire, an optical cable, a Radio Frequency (RF), etc, or any suitable combination of the above.

In some implementations, clients and servers can communicate using any currently known or future developed network protocol such as a HyperText Transfer Protocol (HTTP), and can intercommunicate and be interconnected with digital data in any form or medium (for example, a communication network). Examples of the communication network include a Local Area Network (LAN), a Wide Area Network (WAN), an internet (such as an Internet), a point-to-point network (such as an ad hoc point-to-point network, and any currently known or future developed network.

The computer-readable medium may be included in the electronic device or exist alone and is not assembled into the electronic device.

The above computer-readable medium carries one or more programs. The above one or more programs, when executed by an electronic device, cause the electronic device to: determine a first format media file and a second format media file, wherein the first format media file is obtained by converting the second format media file into a preset encapsulation format;

determine preset file index information from the first format media file, wherein the preset file index information records a mapping correspondence relationship from first target media data to second target media data; the first target media data includes target media data that has been deleted from the first format media file; the second target media data includes target media data, which has the same data content as the first target media data, in the second format media file; and

regenerate, based on the preset file index information, the first format media file using the second target media data in the second format media file.

Computer program codes for performing the operations of the present application may be written in one or more programming languages or a combination thereof. The above programming languages include but are not limited to an object-oriented programming language such as Java, Smalltalk, and C++, and conventional procedural programming languages such as “C” language or similar programming languages. The program codes may be executed entirely on a user computer, partly on a user computer, as a stand-alone software package, partly on a user computer and partly on a remote computer, or entirely on a remote computer or a server. In the case of the remote computer, the remote computer may be connected to the computer of the user through any kind of network, including a local area network (LAN) or a wide area network (WAN), or may be connected to an external computer (for example, connected through the Internet with the aid of an Internet service provider).

The flowcharts and block diagrams in the accompanying drawings illustrate possible system architectures, functions, and operations that may be implemented by a system, a method, and a computer program product according to various embodiments of the present disclosure. In this regard, each block in a flowchart or a block diagram may represent a module, a program, or a part of a code. The module, the program, or the part of the code includes one or more executable instructions used for implementing specified logic functions. In some implementations used as substitutes, functions annotated in blocks may alternatively occur in a sequence different from that annotated in an accompanying drawing. For example, actually two blocks shown in succession may be performed basically in parallel, and sometimes the two blocks may be performed in a reverse sequence. This is determined by a related function. It is also be noted that each box in a block diagram and/or a flowchart and a combination of boxes in the block diagram and/or the flowchart may be implemented by using a dedicated hardware-based system configured to perform a specified function or operation, or may be implemented by using a combination of dedicated hardware and a computer instruction.

The units described in the embodiments of the present application can be implemented through software or hardware. The name of the unit does not constitute a limitation on the unit itself. For example, the first obtaining unit can also be described as “a unit that obtains at least two Internet protocol addresses”.

The functions described herein above may be performed, at least in part, by one or a plurality of hardware logic components. For example, nonrestrictively, example hardware logic components that can be used include: a Field Programmable Gate Array (FPGA), an Application Specific Integrated Circuit (ASIC), Application Specific Standard Parts (ASSP), a System on Chip (SOC), a Complex Programmable Logic Device (CPLD), etc.

In the context of the present disclosure, a machine-readable medium may be a tangible medium that may include or store a program for use by an instruction execution system, apparatus, or device or in connection with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the above content. More specific examples of the machine-readable medium may include an electrical connection based on one or more wires, a portable computer disk, a hard disk drive, a RAM, a ROM, an EPROM or flash memory, an optical fiber, a CD-ROM, an optical storage device, a magnetic storage device, or any suitable combinations of the above contents.

According to one or more embodiments of the present disclosure, Example 1 provides a media file generating method, including: determining a first format media file and a second format media file, wherein the first format media file is obtained by converting the second format media file into a preset encapsulation format;

determining preset file index information from the first format media file, wherein the preset file index information records a mapping correspondence relationship from first target media data to second target media data; the first target media data includes target media data that has been deleted from the first format media file; the second target media data includes target media data, which has the same data content as the first target media data, in the second format media file; and

regenerating, based on the preset file index information, the first format media file using the second target media data in the second format media file.

In Example 2, in the method according to Example 1, the first format media file is generated by:

performing encapsulation format conversion on the second format media file to obtain a reference media file, and deleting the first target media data from the reference media file;

analyzing metadata information in the reference media file to obtain the preset file index information, wherein the metadata information comprises preset description information of all media data in the reference media file; and

adding the preset file index information to the reference media file from which the first target media data has been deleted, to obtain the first format media file.

In Example 3, in the method according to Example 1, determining the first format media file and the second format media file includes:

receiving a media data packet, wherein the media data packet includes media files in different encapsulation formats; and

in response to an access request for the first format media file, analyzing the received media data packet to obtain the first format media file and the second format media file which are stored in an association,

wherein the second target media data that has the same data content as the first target media data is not deleted from the second format media file; and an audio and video encoding parameter used in the first format media file and an audio and video encoding parameter used in the second format media file are the same.

In Example 4, in the method according to Example 1, the preset file index information includes a mapping correspondence relationship from first offset information to second offset information; the first offset information describes a first offset position of the first target media data relative to the first format media file before the first target media data is deleted, and the second offset information describes a second offset position of the second target media data relative to the second format media file.

In Example 5, in the method according to Example 4, the preset file index information further includes media type information; the media type information describes a media type of the same target media data corresponding to a mapping from the first offset information to the second offset information; and the media type information is represented by a numerical value.

In Example 6, in the method according to Example 4, the preset file index information is generated by:

determining the first offset position of the first target media data before deletion relative to the first format media file;

determining, from the second format media file, the second offset position of the second target media data relative to the second format media file; and

constructing the preset file index information by performing mapping correspondence on the first offset position and the second offset position which point to the same target media data.

In Example 7, in the method according to Example 6, determining the first offset position of the first target media data before deletion relative to the first format media file includes:

interleaving and sorting each of the first target media data based on media types of the first target media data, according to a size of each of the first target media data that has been deleted from the first format media file; and

recording the first offset position, before deletion relative to the first format media file, of each of the first target media data that is interleaved and sorted and the media types of the first target media data, wherein the media types of at least two adjacent pieces of first target media data that are interleaved and sorted are different.

In Example 8, in the method according to Example 6, determining, from the second format media file, the second offset position of the second target media data relative to the second format media file includes:

when a current piece of the first target media data that has been deleted from the first format media file is headmost piece of target media data, searching the second target media data of the second format media file for headmost piece of target media data according to the media type of the current piece of the first target media data, and determining the headmost piece of target media data to be second target media data that is the same as the current piece of the first target media data, wherein the searched headmost piece of target media data has the same media type as the current piece of the first target media data; and

determining the second offset position of the second target media data relative to the second format media file.

In Example 9, in the method according to Example 6, determining, from the second format media file, the second offset position of the second target media data relative to the second format media file includes:

when a current piece of the first target media data that has been deleted from the first format media file is not headmost piece of target media data, determining a previous offset position and a current offset position, and determining a size of a previous piece of the first target media data according to the previous offset position and the current offset position, wherein the current offset position is a first offset position, before deletion relative to the first format media file, of the current piece of the first target media data that has been deleted from the first format media file; the previous offset position is a first offset position, before deletion relative to the first format media file, of the previous piece of the target media data that has been deleted from the first format media file and is in front of the current piece of the first target media data;

according to the size of the previous piece of the first target media, the media type of the current piece of the first target media data, and a reference offset position, searching the second format media file for the second target media data that is the same as the current piece of the first target media data; and determining the second offset position, relative to the second format media file, of the second target media data that is the same as the current piece of the first target media data,

wherein the reference offset position is the second offset position of second target media data, which is the same as the previous piece of the first target media, in the second format media file relative to the second format media file.

In Example 10, in the method according to Example 4, regenerating, based on the preset file index information, the first format media file using the second target media data in the second format media file includes:

during accessing to the first format media file, reading pre-reserved file header data from the first format media file, wherein the pre-reserved file header data records the first offset information;

reading, from the pre-reserved file header data, first offset information required by the first target media data that has been deleted; and

regenerating the first format media file using the second target media data in the second format media file according to the first offset information required by the first target media data that has been deleted and the preset file index information.

In Example 11, in the method according to Example 10, regenerating the first format media file using the second target media data in the second format media file according to the first offset information required by the first target media data that has been deleted and the preset file index information includes:

matching the first offset information required by the first target media data that has been deleted with the preset file index information to obtain an offset information matching result, wherein the offset information matching result comprises second offset information that is in mapping association with the first offset information required by the first target media data that has been deleted; and

reading media data at corresponding offset positions from the second target media data of the second format media file according to the offset information matching result, and adding the read media data into the first format media file to reassemble and regenerate the first format media file.

According to one or more embodiments of the present disclosure, Example 12 further provides a media file determining apparatus, including:

a media file determining module, configured to determine a first format media file and a second format media file, wherein the first format media file is obtained by converting the second format media file into a preset encapsulation format;

a preset file index information determining module, configured to determine preset file index information from the first format media file, wherein the preset file index information records a mapping correspondence relationship from first target media data to second target media data; the first target media data includes target media data that has been deleted from the first format media file; the second target media data includes target media data, which has the same data content as the first target media data, in the second format media file; and

a media data generating module, configured to regenerate, based on the preset file index information, the first format media file using the second target media data in the second format media file.

According to one or more embodiments of the present disclosure, Example 13 further provides an electronic device, including:

one or more processors; and

a storage, configured to store one or more programs,

wherein the one or more programs, when executed by the one or more processors, cause the one or more processors to implement the media file generating method of any of Examples 1 to 11.

According to one or more embodiments of the present disclosure, Example 14 provides a storage medium including computer-executable instructions. When executed by a computer processor, the computer-executable instructions are used for performing the media file generating method of any of Examples to 1 to 11.

The foregoing descriptions are merely preferred embodiments of the present disclosure and explanations of the applied technical principles. Those skilled in the art should understand that the scope of disclosure referred to in the present disclosure is not limited to the technical solutions formed by specific combinations of the aforementioned technical features, but also covers other technical solutions formed by any combinations of the aforementioned technical features or their equivalent features without departing from the concept of the above disclosure, for example, a technical solution formed by replacing the above features with (but not limited to) technical features with similar functions disclosed in the present disclosure.

In addition, although various operations are depicted in a specific order, this should not be understood as requiring these operations to be executed in the specific order shown or in a sequential order. In certain environments, multitasking and parallel processing may be advantageous. Similarly, although several specific implementation details are included in the above discussion, these should not be interpreted as limiting the scope of the present disclosure. Some features described in the context of individual embodiments can also be combined and implemented in a single embodiment. On the contrary, various features that are described in the context of the single embodiment may also be implemented in a plurality of embodiments separately or in any suitable sub-combinations.

Although the subject matter has been described in a language specific to structural features and/or method logical actions, it should be understood that the subject matter limited in the attached claims may not necessarily be limited to the specific features or actions described above. On the contrary, the specific features and actions described above are only exemplary forms for implementing the claims.

1. A media file generating method, comprising:
determining a first format media file and a second format media file, the first format media file being obtained by converting the second format media file into a preset encapsulation format;
determining preset file index information from the first format media file, the preset file index information recording a mapping correspondence relationship from first target media data to second target media data, the first target media data comprising target media data that has been deleted from the first format media file, the second target media data comprising target media data, which has same data content as the first target media data, in the second format media file; and
regenerating, based on the preset file index information, the first format media file using the second target media data in the second format media file.

2. The method of claim 1, wherein the first format media file is generated by:
performing encapsulation format conversion on the second format media file to obtain a reference media file, and deleting the first target media data from the reference media file;
analyzing metadata information in the reference media file to obtain the preset file index information, wherein the metadata information comprises preset description information of all media data in the reference media file; and
adding the preset file index information to the reference media file from which the first target media data has been deleted to obtain the first format media file.

3. The method of claim 1, wherein determining the first format media file and the second format media file comprises:
receiving a media data packet, wherein the media data packet comprises media files in different encapsulation formats; and
in response to an access request for the first format media file, analyzing the received media data packet to obtain the first format media file and the second format media file which are stored in an association,
wherein the second target media data that has the same data content as the first target media data is not deleted from the second format media file, and an audio and video encoding parameter used in the first format media file and an audio and video encoding parameter used in the second format media file are the same.

4. The method of claim 1, wherein the preset file index information comprises a mapping correspondence relationship from first offset information to second offset information, the first offset information describes a first offset position of the first target media data relative to the first format media file before the first target media data is deleted, and the second offset information describes a second offset position of the second target media data relative to the second format media file.

5. The method of claim 4, wherein the preset file index information further comprises media type information, the media type information describes a media type of same target media data corresponding to a mapping from the first offset information to the second offset information, and the media type information is represented by a numerical value.

6. The method of claim 4, wherein the preset file index information is generated by:
determining the first offset position of the first target media data before deletion relative to the first format media file;
determining, from the second format media file, the second offset position of the second target media data relative to the second format media file; and
constructing the preset file index information by performing mapping correspondence on the first offset position and the second offset position which point to same target media data.

7. The method of claim 6, wherein determining the first offset position of the first target media data before deletion relative to the first format media file comprises:
interleaving and sorting each of the first target media data that has been deleted from the first format media file based on media types of the first target media data, according to a size of each of the first target media data; and
recording the first offset position, before deletion relative to the first format media file, of each of the first target media data that is interleaved and sorted and the media types of the first target media data, wherein the media types of at least two adjacent pieces of the first target media data that are interleaved and sorted are different.

8. The method of claim 6, wherein determining, from the second format media file, the second offset position of the second target media data relative to the second format media file comprises:
in response to a current piece of the first target media data that has been deleted from the first format media file being headmost piece of target media data, searching second target media data of the second format media file for the headmost piece of target media data according to a media type of the current piece of the first target media data, and determining the headmost piece of target media data to be second target media data that is the same as the current piece of the first target media data, wherein the searched headmost piece of target media data has same media type as the current piece of the first target media data; and
determining the second offset position of the second target media data relative to the second format media file.

9. The method of claim 6, wherein determining, from the second format media file, the second offset position of the second target media data relative to the second format media file comprises:
in response to a current piece of the first target media data that has been deleted from the first format media file being not headmost piece of target media data, determining a previous offset position and a current offset position, and determining a size of a previous piece of the first target media data according to the previous offset position and the current offset position, wherein the current offset position is a first offset position, before deletion relative to the first format media file, of the current piece of the first target media data that has been deleted from the first format media file, the previous offset position is a first offset position, before deletion relative to the first format media file, of the previous piece of the target media data that has been deleted from the first format media file and is in front of the current piece of the first target media data;
according to the size of the previous piece of the first target media data, the media type of the current piece of the first target media data, and a reference offset position, searching the second format media file for second target media data that is the same as the current piece of the first target media data, and determining the second offset position, relative to the second format media file, of the second target media data that is the same as the current piece of the first target media data,
wherein the reference offset position is the second offset position of second target media data, which is the same as the previous piece of the first target media data, in the second format media file relative to the second format media file.

10. The method of claim 4, wherein regenerating, based on the preset file index information, the first format media file using the second target media data in the second format media file comprises:
during accessing to the first format media file, reading pre-reserved file header data from the first format media file, wherein the pre-reserved file header data records the first offset information;
reading, from the pre-reserved file header data, first offset information required by the first target media data that has been deleted; and
regenerating the first format media file using the second target media data in the second format media file according to the first offset information required by the first target media data that has been deleted and the preset file index information.

11. The method of claim 10, wherein regenerating the first format media file using the second target media data in the second format media file according to the first offset information required by the first target media data that has been deleted and the preset file index information comprises:
matching the first offset information required by the first target media data that has been deleted with the preset file index information to obtain an offset information matching result, wherein the offset information matching result comprises second offset information that is in mapping association with the first offset information required by the first target media data that has been deleted; and
reading media data at corresponding offset positions from the second target media data of the second format media file according to the offset information matching result, and adding the read media data into the first format media file to reassemble and regenerate the first format media file.

12. (canceled)

13. An electronic device, comprising:
one or more processors; and
a storage, configured to store one or more programs,
wherein the one or more programs, when executed by the one or more processors, cause the one or more processors to:
determine a first format media file and a second format media file, the first format media file being obtained by converting the second format media file into a preset encapsulation format;
determine preset file index information from the first format media file, the preset file index information recording a mapping correspondence relationship from first target media data to second target media data, the first target media data comprising target media data that has been deleted from the first format media file, the second target media data comprising target media data, which has same data content as the first target media data, in the second format media file; and
regenerate, based on the preset file index information, the first format media file using the second target media data in the second format media file.

14. A non-transitory storage medium comprising computer-executable instructions, wherein the computer-executable instructions, when executed by a processor, cause the processor to:
determine a first format media file and a second format media file, the first format media file being obtained by converting the second format media file into a preset encapsulation format;
determine preset file index information from the first format media file, the preset file index information recording a mapping correspondence relationship from first target media data to second target media data, the first target media data comprising target media data that has been deleted from the first format media file, the second target media data comprising target media data, which has same data content as the first target media data, in the second format media file; and
regenerate, based on the preset file index information, the first format media file using the second target media data in the second format media file.

15. The electronic device of claim 13, wherein the preset file index information comprises a mapping correspondence relationship from first offset information to second offset information, the first offset information describes a first offset position of the first target media data relative to the first format media file before the first target media data is deleted, and the second offset information describes a second offset position of the second target media data relative to the second format media file.

16. The electronic device of claim 15, wherein the one or more programs comprise instructions to generate the preset file index information, the instructions, when executed by the one or more processors, cause the one or more processors to:
determine the first offset position of the first target media data before deletion relative to the first format media file;
determine, from the second format media file, the second offset position of the second target media data relative to the second format media file; and
construct the preset file index information by performing mapping correspondence on the first offset position and the second offset position which point to same target media data.

17. The electronic device of claim 16, wherein the instructions that cause the one or more processors to determine the first offset position of the first target media data before deletion relative to the first format media file comprise instructions to cause one or more processors to:
interleave and sort each of the first target media data that has been deleted from the first format media file based on media types of the first target media data, according to a size of each of the first target media data; and
record the first offset position, before deletion relative to the first format media file, of each of the first target media data that is interleaved and sorted and the media types of the first target media data, wherein the media types of at least two adjacent pieces of the first target media data that are interleaved and sorted are different.

18. The electronic device of claim 16, wherein the instructions that cause the one or more processors to determine, from the second format media file, the second offset position of the second target media data relative to the second format media file comprise instructions to cause the one or more processors to:
in response to a current piece of the first target media data that has been deleted from the first format media file being headmost piece of target media data, search second target media data of the second format media file for the headmost piece of target media data according to a media type of the current piece of the first target media data, and determine the headmost piece of target media data to be second target media data that is the same as the current piece of the first target media data, wherein the searched headmost piece of target media data has same media type as the current piece of the first target media data; and
determine the second offset position of the second target media data relative to the second format media file.

19. The electronic device of claim 16, wherein the instructions that cause the one or more processors to determine, from the second format media file, the second offset position of the second target media data relative to the second format media file comprise instructions to cause the one or more processors to:
in response to a current piece of the first target media data that has been deleted from the first format media file being not headmost piece of target media data, determine a previous offset position and a current offset position, and determine a size of a previous piece of the first target media data according to the previous offset position and the current offset position, wherein the current offset position is a first offset position, before deletion relative to the first format media file, of the current piece of the first target media data that has been deleted from the first format media file, the previous offset position is a first offset position, before deletion relative to the first format media file, of the previous piece of the target media data that has been deleted from the first format media file and is in front of the current piece of the first target media data;
according to the size of the previous piece of the first target media data, the media type of the current piece of the first target media data, and a reference offset position, search the second format media file for second target media data that is the same as the current piece of the first target media data, and determine the second offset position, relative to the second format media file, of the second target media data that is the same as the current piece of the first target media data,
wherein the reference offset position is the second offset position of second target media data, which is the same as the previous piece of the first target media data, in the second format media file relative to the second format media file.

20. The electronic device of claim 15, wherein the one or more programs that cause the one or more processors to regenerate, based on the preset file index information, the first format media file using the second target media data in the second format media file comprise instructions to cause the one or more processors to:
during accessing to the first format media file, read pre-reserved file header data from the first format media file, wherein the pre-reserved file header data records the first offset information;
read, from the pre-reserved file header data, first offset information required by the first target media data that has been deleted; and
regenerate the first format media file using the second target media data in the second format media file according to the first offset information required by the first target media data that has been deleted and the preset file index information.

21. The electronic device of claim 20, wherein the instructions that cause the one or more processors to regenerate the first format media file using the second target media data in the second format media file according to the first offset information required by the first target media data that has been deleted and the preset file index information comprise instructions to cause the one or more processors to:
match the first offset information required by the first target media data that has been deleted with the preset file index information to obtain an offset information matching result, wherein the offset information matching result comprises second offset information that is in mapping association with the first offset information required by the first target media data that has been deleted; and
read media data at corresponding offset positions from the second target media data of the second format media file according to the offset information matching result, and adding the read media data into the first format media file to reassemble and regenerate the first format media file.
